(19) United States
(12) Patent Application Publication
(10) Pub. No.: US 2026/0094801 A1
(43) Pub. Date: Apr. 2, 2026

(54) MANUFACTURING METHOD FOR NEGATIVE ELECTRODE

(71) Applicant: TOYOTA JIDOSHA KABUSHIKI KAISHA, Toyota-shi (JP)

(72) Inventors: Minehiro FUNATO, Toyota-shi (JP); Nariaki MIKI, Okazaki-shi (JP); Tomoyuki UEZONO, Okazaki-shi (JP)

(73) Assignee: TOYOTA JIDOSHA KABUSHIKI KAISHA, Toyota-shi (JP)

(21) Appl. No.: 19/296,195

(22) Filed: Aug. 11, 2025

(30) Foreign Application Priority Data
Sep. 27, 2024 (JP) 2024-168403

(51) Int. Cl. H01M 4/04

(52) U.S. Cl. CPC H01M 4/0404

(57) ABSTRACT

A manufacturing method for a negative electrode includes: supplying a negative electrode mixed material containing graphite to a metal foil serving as a current collector; and applying a magnetic field to the negative electrode mixed material supplied to the metal foil. The supplying of the negative electrode mixed material is supplying the negative electrode mixed material to the metal foil conveyed along an outer peripheral surface of a magnet roll serving as a backup roll. The applying of the magnetic field includes a first magnetic field applying step of applying, by the magnet roll, a magnetic field to the negative electrode mixed material, and a second magnetic field applying step of further applying, after the metal foil supplied with the negative electrode mixed material passes the magnet roll, a magnetic field to the negative electrode mixed material.

### CROSS-REFERENCE TO RELATED APPLICATION

This application claims priority to Japanese Patent Application No. 2024-168403 filed on Sep. 27, 2024. The disclosure of the above-identified application, including the specification, drawings, and claims, is incorporated by reference herein in its entirety.

### BACKGROUND

### 1. Technical Field

The present disclosure relates to a manufacturing method for a negative electrode.

### 2. Description of Related Art

Japanese Unexamined Patent Application Publication No. 2024-073970 (JP 2024-073970 A) discloses a manufacturing method for a lithium-ion secondary battery, the method including the steps of supplying a negative electrode mixed material containing graphite to a metal foil serving as a current collector, and applying a magnetic field to the negative electrode mixed material, and discloses, as one embodiment thereof, an embodiment in which a back roll that supports the metal foil is a magnetic field roll.

Japanese Examined Patent Publication No. 6-105644 (JP 6-105644 B) discloses a magnet roll in which a plurality of magnetic pole pieces is installed along a circumferential direction.

### SUMMARY

As disclosed in JP 2024-073970 A, when the graphite in the negative electrode mixed material is oriented only by the magnet roll, the orientation is performed in a high shear rate region (having a low viscosity), and hence, although the degree of orientation is improved, it is difficult to obtain a negative electrode having a high degree of orientation because an orientation time is insufficient.

The present disclosure has been made in view of the above-mentioned circumstance, and has a primary object to provide a manufacturing method for a negative electrode with which a degree of orientation of graphite in a negative electrode mixed material can be improved.

In other words, the present disclosure includes the following aspects.
<1> A first aspect of the disclosure relates to a manufacturing method for a negative electrode, the manufacturing method including:
   supplying a negative electrode mixed material containing graphite to a metal foil serving as a current collector; and
   applying a magnetic field to the negative electrode mixed material supplied to the metal foil, in which:
the supplying of the negative electrode mixed material is supplying the negative electrode mixed material to the metal foil conveyed along an outer peripheral surface of a magnet roll serving as a backup roll; and
the applying of the magnetic field includes a first magnetic field applying step of applying, by the magnet roll, a magnetic field to the negative electrode mixed material, and a second magnetic field applying step of further applying, after the metal foil supplied with the negative electrode mixed material passes the magnet roll, a magnetic field to the negative electrode mixed material.
<2> In the manufacturing method for the negative electrode according to <1>, in the first magnetic field applying step, a holding angle of the magnet roll to the metal foil supplied with the negative electrode mixed material may be 90 degrees or more and 350 degrees or less.
<3> In the manufacturing method for the negative electrode according to <1>, in the first magnetic field applying step, a holding angle of the magnet roll to the metal foil supplied with the negative electrode mixed material may be 180 degrees or more and 350 degrees or less.

With the present disclosure, the degree of orientation of the graphite in the negative electrode mixed material can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating an example of a configuration of a negative electrode manufacturing device;

FIG. 2 is a view illustrating another example of the configuration of the negative electrode manufacturing device;

FIG. 3 is a view illustrating further another example of the configuration of the negative electrode manufacturing device;

FIG. 4 is a view illustrating a specific example of a magnet roll;

FIG. 5 is a graph illustrating a correspondence relationship between a shear rate and a viscosity of a negative electrode mixed material; and

FIG. 6 is a graph illustrating a correspondence relationship between a degree of orientation of each of negative electrode samples 1 to 7 and a magnetic field application time.

### DETAILED DESCRIPTION OF EMBODIMENTS

In order to improve a degree of orientation of graphite in a negative electrode mixed material in magnetic field orientation, for example, measures such as decreasing the viscosity of the negative electrode mixed material, slowing down a conveyance speed of a metal foil serving as a current collector to increase the orientation time, or increasing a size of a magnet for magnetic field orientation have conventionally been performed. In a manufacturing method of the present disclosure, a magnet roll is used as a backup roll that supports a metal foil. A first magnetic field applying step of applying, by the magnet roll, a magnetic field to a negative electrode mixed material immediately after coating to the metal foil is performed, and then a second magnetic field applying step of further applying a magnetic field to the negative electrode mixed material on the metal foil that has passed the magnet roll is performed. In the manufacturing method of the present disclosure, after the graphite in the negative electrode mixed material is oriented by the first magnetic field applying step, the degree of orientation can be further improved by the second magnetic field applying step. Thus, the degree of orientation of the graphite in the negative electrode mixed material can be improved than the related-art method. Further, in the first magnetic field applying step, a magnetic field is applied to the negative electrode mixed material in a low viscosity state in a high shear rate region. Thus, the degree of orientation of the graphite in the negative electrode mixed material can be improved in a shorter time than applying the magnetic field to the negative electrode mixed material in a high viscosity state. Accordingly, in the manufacturing method of the present disclosure, a magnetic field application time (an orientation time) for bringing the graphite in the negative electrode mixed material to have a sufficient degree of orientation can be shortened.

Moreover, in the manufacturing method of the present disclosure, the degree of orientation of the graphite in the negative electrode mixed material can be sufficiently increased by the first and second magnetic field applying steps, and hence there is no need to lower the viscosity of the negative electrode mixed material. Accordingly, it is possible to increase the thickness of the negative electrode mixed material, and, for example, the negative electrode mixed material can have a basis weight after drying of 25 mg/cm² or more (for example, 25 mg/cm² to 100 mg/cm²). Further, sagging of a coating end can be reduced because the negative electrode mixed material is not lowered in viscosity.

Moreover, in the manufacturing method of the present disclosure, in the first magnetic field applying step, the backup roll is a magnet for use in applying a magnetic field, and hence it is not required to place a large magnet for use in applying a magnetic field. Further, with the first magnetic field applying step and the second magnetic field applying step being performed, the graphite in the negative electrode mixed material can have a sufficient degree of orientation even when magnetic field applying means to be used in the second magnetic field applying step is reduced in size. Thus, the manufacturing method of the present disclosure can achieve downsizing of the device and reduction in cost.

Hereinafter, with reference to the drawings, an embodiment of the present disclosure is described, but the present disclosure is not limited to the embodiment described here. Further, the dimensional relationship (a length, a width, a thickness, and the like) in each drawing does not reflect an actual dimensional relationship. Members and parts having the same actions are denoted by the same reference symbols, and redundant description thereof is omitted or simplified in some cases.

It is to be noted that matters necessary to carry out the present disclosure other than those specifically referred to in this specification (for example, general configurations and manufacturing processes of a negative electrode manufacturing device that do not characterize the present disclosure) may be understood as design matters for a person skilled in the art that are based on the related art in the pertinent field. The present disclosure may be carried out based on the contents disclosed herein and common general technical knowledge in the pertinent field.

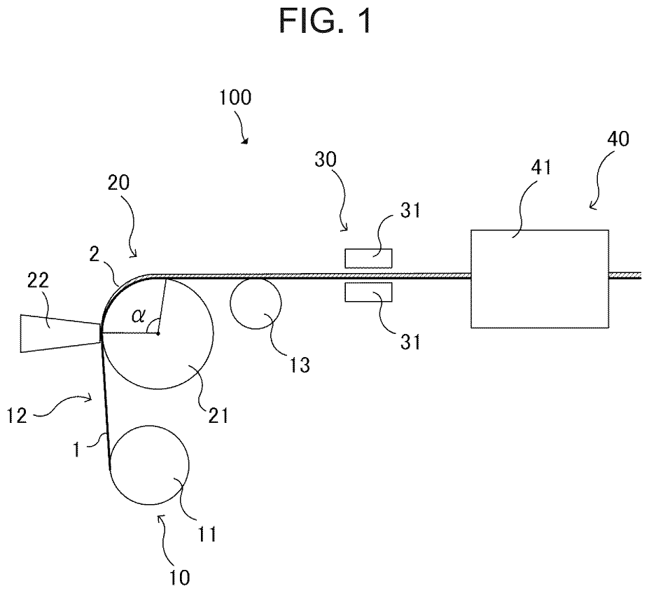

FIG. 1 illustrates a configuration of a negative electrode manufacturing device to be used in one embodiment of the present disclosure.

A negative electrode manufacturing device 100 illustrated in FIG. 1 includes a metal foil supply unit 10, a first magnetic field applying unit 20, a second magnetic field applying unit 30, and a drying unit 40.

In the metal foil supply unit 10, a metal foil 1 (for example, a copper foil) serving as a current collector wound around a winding core 11 is unwound to be supplied to a travel path 12. The travel path 12 may include a guide 13 that allows the metal foil 1 to travel along a predetermined path.

In the first magnetic field applying unit 20, a step of supplying a negative electrode mixed material 2 containing graphite to the metal foil 1 and a first magnetic field applying step of applying, by a magnet roll 21 serving as a backup roll that supports the metal foil 1, a magnetic field to the negative electrode mixed material 2 supplied to the metal foil 1 are performed.

The negative electrode mixed material 2 is a paste mixed material containing graphite as a negative electrode active material. The viscosity of the negative electrode mixed material 2 may be, for example, when measured under a condition of a shear rate of 0.01 s⁻¹, about 1.0×10⁵ mPa·s to 5.0×10⁵ mPa·s, or may be, when measured under a condition of a shear rate of 100 s⁻¹, about 1.0×10³ mPa·s to 5.0×10³ mPa·s.

The graphite in the negative electrode mixed material 2 is only required to be a material that is oriented by a magnetic field. The graphite has, for example, a layer structure in which hexagonal plate crystals overlap to form a plurality of layers. Specifically, natural graphite, artificial graphite, or carbon-based materials, such as amorphous carbons of those, are used.

The negative electrode mixed material 2 may further contain a binder (a binding agent), such as styrene-butadiene rubber (SBR), an electrically conductive auxiliary agent, such as vapor-grown carbon fibers (VGCF) or carbon nanotubes (CNT), a thickener, such as carboxymethyl cellulose (CMC), a solvent, or the like.

The first magnetic field applying unit 20 includes the magnet roll 21 serving as the backup roll for the metal foil 1, and a die 22 that ejects the negative electrode mixed material 2. The magnet roll 21 is a roller disposed along the travel path 12 to support the metal foil 1, and is also a magnet that applies a magnetic field to the negative electrode mixed material 2 on the metal foil 1. The die 22 is provided to face the magnet roll 21, and the die 22 ejects and supplies the negative electrode mixed material 2 to the metal foil 1 conveyed along the outer peripheral surface of the magnet roll 21. In the first magnetic field applying unit 20, at the same time as supplying the negative electrode mixed material 2 to the metal foil 1, the magnet roll 21 that supports the metal foil 1 applies a magnetic field to the negative electrode mixed material 2 on the metal foil 1. Accordingly, in a high shear rate region (which may be, for example, a region having a shear rate of 100 s⁻¹ or more or a region having a shear rate of 100 s⁻¹ to 600 s⁻¹) at the time of coating, the magnetic field can be applied to the negative electrode mixed material 2, with the result that the degree of orientation of the graphite in the negative electrode mixed material 2 can be improved in a short time.

In the first magnetic field applying step, a holding angle of the magnet roll 21 to the metal foil 1 supplied with the negative electrode mixed material 2 is increased, and thus the time of applying the magnetic field to the negative electrode mixed material 2 on the metal foil 1 (that is, the orientation time) can be increased without slowing down the conveyance speed of the metal foil 1. Here, the holding angle of the magnet roll 21 to the metal foil 1 supplied with the negative electrode mixed material 2 refers to an angle between, in a state in which the metal foil 1 holds the negative electrode mixed material 2 on its surface, a start point of contact to the magnet roll 21 and an end point of contact at which separation from the magnet roll 21 starts, with reference to a center point of a cross section of the magnet roll 21. The start point of the above-mentioned holding angle may be a position of an ejection port of the die 22. The above-mentioned holding angle can be used as an index of a size of a magnetic field applying region or the orientation time in the first magnetic field applying step. The above-mentioned holding angle may be, for example, 90 degrees or more, 120 degrees or more, 180 degrees or more, 200 degrees or more, or 270 degrees or more, and may be, from the viewpoint of easiness in the manufacturing method, 350 degrees or less, 300 degrees or less, 270 degrees or less, or 200 degrees or less. For example, increasing the above-mentioned holding angle from 90 degrees to 270 degrees allows the orientation time in the first magnetic field applying step to be increased by three times. It is to be noted that, in the manufacturing method of the present disclosure, there is no need to lower the viscosity of the negative electrode mixed material 2 as described above, and hence the above-mentioned holding angle can be increased.

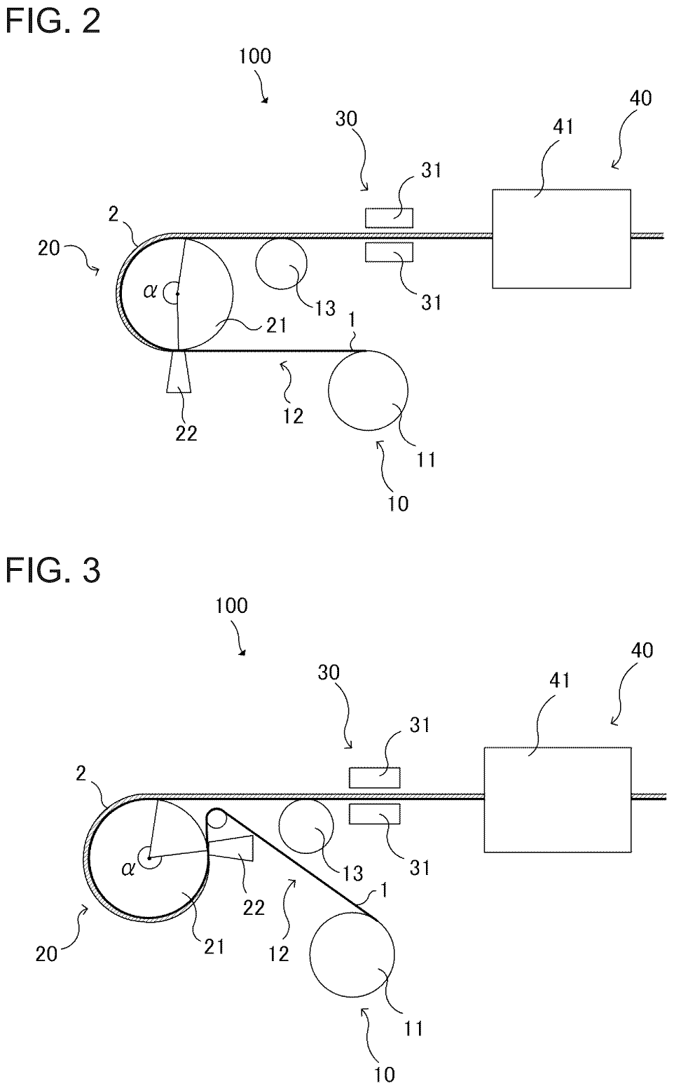

Examples of the configurations of the negative electrode manufacturing devices that have increased the above-mentioned holding angle relative to the negative electrode manufacturing device 100 illustrated in FIG. 1 are illustrated in FIG. 2 and FIG. 3. In FIG. 1, FIG. 2, and FIG. 3, the above-mentioned holding angle is represented by a.

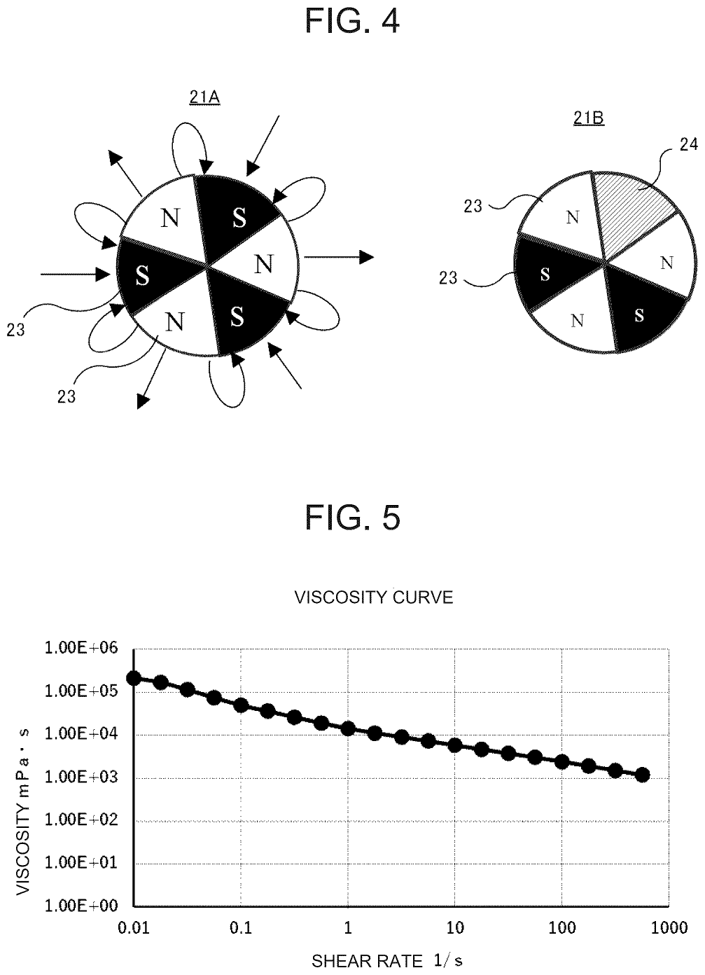

As the magnet roll 21, for example, as in a magnet roll 21A illustrated in FIG. 4, a magnet roll in which a plurality of magnetic pole portions 23 is disposed such that an S pole and an N pole are alternately disposed along the circumferential direction and the S pole and the N pole face each other can be used. It is to be noted that the arrow illustrated in FIG. 4 indicates a direction of a magnetic flux.

Further, a magnet roll including a magnetic pole portion 23 and a non-magnetic material portion 24 can also be used. As the magnet roll including the magnetic pole portion 23 and the non-magnetic material portion 24, for example, as in a magnet roll 21B illustrated in FIG. 4, a magnet roll in which some of the magnetic pole portions 23 are replaced with the non-magnetic material portion 24 in the magnet roll in which the magnetic pole portions 23 are disposed such that the S pole and the N pole are alternately disposed along the circumferential direction and the S pole and the N pole face each other can be used. With the use of such a magnet roll having some configured of the non-magnetic material portion, the orientation of the graphite in the negative electrode mixed material 2 can be set as a pattern orientation along the conveyance direction of the metal foil 1. It is to be noted that, even when the second magnetic field applying step is performed after the pattern orientation is performed in the first magnetic field applying step, the pattern orientation can be kept due to the difference in magnetic field application time. For example, the pattern orientation may be performed at the middle or the end portion of the negative electrode in accordance with the reaction unevenness of the negative electrode, and the orientation may be performed in any pattern.

In the magnet roll including the magnetic pole portion 23 and the non-magnetic material portion 24, from the viewpoint of sufficiently ensuring the magnetic field applying region in the first magnetic field applying step and the viewpoint of performing a desired pattern orientation, an area ratio (“magnetic pole portion”:“non-magnetic material portion”) between the magnetic pole portion 23 and the non-magnetic material portion 24 in the cross section orthogonal to the roll axis may be, for example, 95:5 to 80:20.

In the second magnetic field applying unit 30, the second magnetic field applying step of further applying, after the metal foil 1 supplied with the negative electrode mixed material 2 passes the magnet roll 21, a magnetic field to the negative electrode mixed material 2 is performed. The second magnetic field applying step may be a step of orientating the graphite in the negative electrode mixed material 2 by applying a magnetic field to the negative electrode mixed material 2 in a relatively low shear rate region (which may be, for example, a region having a shear rate of 0.01 s⁻¹ or less, or a region having a shear rate of 0.01 s⁻¹ to 0.05 s⁻¹) after a predetermined time has elapsed from the coating.

Magnetic field applying means in the second magnetic field applying unit 30 is not particularly limited. In the manufacturing method of the present disclosure, the orientation is performed by the above-mentioned first magnetic field applying step, and hence the graphite in the negative electrode mixed material can have a sufficient degree of orientation even when the magnetic field applying means in the second magnetic field applying unit 30 is reduced in size. The magnetic field applying means in the second magnetic field applying unit 30 may be, for example, as illustrated in FIG. 1, a pair of magnets 31 provided to sandwich and face the metal foil 1 traveling on the travel path 12. In this case, the magnets 31 disposed to sandwich and face the metal foil 1 are disposed such that one of the magnets 31 becomes the S pole and the other becomes the N pole toward the metal foil 1. The magnets 31 may be configured of, for example, permanent magnets, or may be configured of electromagnets that generate magnetic forces due to the action of electricity.

The manufacturing method of the present disclosure at least includes the above-mentioned first magnetic field applying step and second magnetic field applying step as the step of applying a magnetic field to the negative electrode mixed material 2 supplied to the metal foil 1.

In the manufacturing method of the present disclosure, the magnetic field to be applied to the negative electrode mixed material 2 is a magnetic field in which the magnetic field lines are directed to the surface of the metal foil 1 on which the negative electrode mixed material 2 is supplied, and may be, for example, a magnetic field in which the magnetic field lines are directed to a direction orthogonal to the surface of the metal foil 1 on which the negative electrode mixed material 2 is supplied. The “direction orthogonal” as used herein is not required to be completely orthogonal and may be substantially orthogonal.

In the drying unit 40, a drying furnace 41 is provided along the travel path 12. The drying furnace 41 applies heat to the negative electrode mixed material 2 to which the magnetic field is applied by the first magnetic field applying unit 20 and the second magnetic field applying unit 30 to dry the negative electrode mixed material 2.

The negative electrode obtained by the manufacturing method of the present disclosure can be used in, for example, a battery, such as a lithium-ion battery. With the degree of orientation of the graphite in the negative electrode mixed material being improved by the manufacturing method of the present disclosure, in the negative electrode of the battery, a diffusion property of ions, such as lithium ions, can be improved.

The battery using the negative electrode obtained by the manufacturing method of the present disclosure may be a primary battery or a secondary battery, but may be, among them, a secondary battery. The reason therefor is because the secondary battery can be repeatedly charged and discharged, and is effective as, for example, an in-vehicle battery. The shape of the battery is not particularly limited, and may be, for example, a coin shape, a cylindrical shape, a rectangular shape, a sheet shape, a button shape, a flat shape, or a stack shape.

Examples of the application of the battery including the negative electrode obtained by the manufacturing method of the present disclosure include power supplies for vehicles, such as a hybrid electric vehicle (HEV), a plug-in hybrid electric vehicle (PHEV), a battery electric vehicle (BEV), a gasoline-powered vehicle, and a diesel-powered vehicle. In particular, the battery may be used for a driving power supply of a hybrid electric vehicle (HEV), a plug-in hybrid electric vehicle (PHEV), or a battery electric vehicle (BEV). Further, the battery may be used as a power supply of a moving body other than a vehicle (for example, a railway vehicle, a ship, or an aircraft), or may be used as a power supply of an electrical product such as an information processing device.

### Evaluation Test

The following test was performed to verify the relationship between the viscosity (shear rate) of the negative electrode mixed material and the degree of orientation of the graphite in the negative electrode mixed material.

Artificial graphite serving as a negative electrode active material, CMC serving as a thickener, SBR serving as a binder, and CNT paste serving as electrically conductive auxiliary agent were mixed and dispersed by a planetary mixer to achieve a mass ratio (active material/thickener/binder/electrically conductive auxiliary agent) of 97.95/0.4/1.6/0.05 (wt %), and a paste negative electrode mixed material was obtained.

The viscosity in a region having a shear rate of 0.01 s⁻¹ to 1,000 s⁻¹ was measured for the obtained negative electrode mixed material. The graph of the correspondence relationship between the shear rate and the viscosity of the negative electrode mixed material is illustrated in FIG. 5. The viscosity of the negative electrode mixed material measured under the condition of a shear rate of 0.01 s⁻¹ was 212,530 mPa·s.

### Negative Electrode Sample 1

After a magnet for magnetic field orientation (having a magnetic flux density of 500 mT) was disposed under a glass plate, a surface of the glass plate on a side opposite to the side on which the magnet is present was coated with the negative electrode mixed material obtained as described above by an applicator such that the basis weight on one surface after the drying was 27.8 mg/cm², and the negative electrode mixed material was dried at a time point at which two seconds have elapsed from the coating to form a negative electrode mixed material layer (that is, the magnetic field application time was two seconds). Thus, a negative electrode sample 1 was produced.

### Negative Electrode Samples 2 and 3

Except for the change in time from the coating to the drying of the negative electrode mixed material (the magnetic field application time), a negative electrode sample 2 and a negative electrode sample 3 were produced in a way similar to the negative electrode sample 1. The magnetic field application time was changed from two seconds to five seconds in the negative electrode sample 2, and was changed from two seconds to 20 seconds in the negative electrode sample 3.

### Negative Electrode Sample 4

A surface of a glass plate was coated with the negative electrode mixed material obtained as described above by an applicator such that the basis weight on one surface after the drying was 27.8 mg/cm², and a magnet for magnetic field orientation (having a magnetic flux density of 500 mT) was disposed under the glass plate (on a side opposite to the surface coated with the negative electrode mixed material) after a predetermined time has elapsed. Then, the negative electrode mixed material was dried at a time point at which two seconds have elapsed from the disposition of the magnet (that is, the magnetic field application time was two seconds). Thus, a negative electrode sample 4 was produced.

### Negative Electrode Samples 5 and 6

Except for the change in time from the disposition of the magnet to the drying of the negative electrode mixed material (the magnetic field application time), a negative electrode sample 5 and a negative electrode sample 6 were produced in a way similar to the negative electrode sample 4. The magnetic field application time was changed from two seconds to five seconds in the negative electrode sample 5, and was changed from two seconds to 20 seconds in the negative electrode sample 6.

### Negative Electrode Sample 7

Except for the non-disposition of the magnet for magnetic field orientation under the glass plate, a negative electrode sample 7 was produced in a way similar to the negative electrode sample 1.

In the negative electrode samples 1, 2, and 3, magnetic field application was performed to the negative electrode mixed material at the same time as the coating of the negative electrode mixed material, similarly to the first magnetic field applying step in the manufacturing method of the present disclosure, thereby orientating the graphite in the negative electrode mixed material in a high shear rate region. Meanwhile, in the negative electrode samples 4, 5, and 6, magnetic field application was performed after an elapse of a predetermined time from the coating of the negative electrode mixed material, thereby orientating the graphite in the negative electrode mixed material in a relatively low shear rate region. In the negative electrode sample 7, the magnetic field application was not performed.

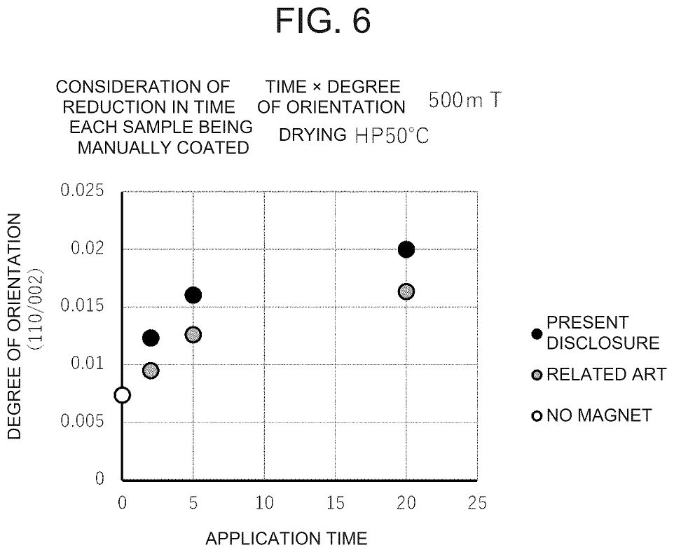

Through X-ray diffraction (XRD), a peak intensity of the (110) plane and a peak intensity of the (002) plane of each negative electrode sample were measured, and a ratio of those peak intensities (110/002) was calculated as the degree of orientation. FIG. 6 illustrates a graph of the correspondence relationship between the degree of orientation of each of the negative electrode samples 1 to 7 and the magnetic field application time. In FIG. 6, the horizontal axis represents the magnetic field application time, and the vertical axis represents the degree of orientation. The negative electrode samples 1, 2, and 3 are represented by “present disclosure”, and the negative electrode samples 4, 5, and 6 are represented by “related art”. The negative electrode sample 7 is represented by “no magnet”. As illustrated in FIG. 6, when the degrees of orientation of the negative electrode samples 1, 2 and 3 and the degrees of orientation of the negative electrode samples 4, 5, and 6 are compared with each other with those having the same magnetic field application time, the degrees of orientation of the negative electrode samples 1, 2, and 3 were each higher than the degrees of orientation of the negative electrode samples 4, 5, and 6.

The color of each of the negative electrode samples was measured, and an L value (lightness) was obtained. As a result of comparing the L values of the negative electrode samples 1, 2, and 3 and the L values of the negative electrode samples 4, 5, and 6 with each other with those having the same magnetic field application time, the L values of the negative electrode samples 1, 2, and 3 were each lower than the L values of the negative electrode samples 4, 5, and 6. The L value has a strong correlation with the degree of orientation, and hence, even with the comparison of the L values, it was shown that the degrees of orientation of the negative electrode samples 1, 2, and 3 were each higher than the degrees of orientation of the negative electrode samples 4, 5, and 6.

As described above, it was shown that the degree of orientation was casily improved by orientating the graphite in the negative electrode mixed material in the high shear rate region. Thus, it was shown that, with the manufacturing method of the present disclosure including the first magnetic field applying step of applying a magnetic field to the negative electrode mixed material in the high shear rate region immediately after the coating, the magnetic field application time (the orientation time) for allowing the graphite in the negative electrode mixed material to have a sufficient degree of orientation was allowed to be shortened.

In the manufacturing method of the present disclosure, the second magnetic field applying step is further performed after the first magnetic field applying step. Thus, the degree of orientation can be increased by applying the magnetic field to the negative electrode mixed material in a low viscosity state immediately after the coating in the first magnetic field applying step, and the degree of orientation can be further increased in the following second magnetic field applying step. As a result, the degree of orientation can be improved as compared with the related-art method.

What is claimed is:

1. A manufacturing method for a negative electrode, the manufacturing method comprising:
supplying a negative electrode mixed material containing graphite to a metal foil serving as a current collector; and
applying a magnetic field to the negative electrode mixed material supplied to the metal foil, wherein:
the supplying of the negative electrode mixed material is supplying the negative electrode mixed material to the metal foil conveyed along an outer peripheral surface of a magnet roll serving as a backup roll; and
the applying of the magnetic field includes a first magnetic field applying step of applying, by the magnet roll, a magnetic field to the negative electrode mixed material, and a second magnetic field applying step of further applying, after the metal foil supplied with the negative electrode mixed material passes the magnet roll, a magnetic field to the negative electrode mixed material.

2. The manufacturing method according to claim 1, wherein, in the first magnetic field applying step, a holding angle of the magnet roll to the metal foil supplied with the negative electrode mixed material is 90 degrees or more and 350 degrees or less.

3. The manufacturing method according to claim 1, wherein, in the first magnetic field applying step, a holding angle of the magnet roll to the metal foil supplied with the negative electrode mixed material is 180 degrees or more and 350 degrees or less.
